(19) United States
(12) Patent Application Publication
(10) Pub. No.: US 2016/0132919 A1
(43) Pub. Date: May 12, 2016

(54) Providing Interface to Allow Users to Request Custom Awards

(71) Applicant: Nathan Walkingshaw, Salt Lake City, UT (US)

(72) Inventor: Nathan Walkingshaw, Salt Lake City, UT (US)

(21) Appl. No.: 14/823,614

(22) Filed: Aug. 11, 2015

Related U.S. Application Data
(60) Provisional application No. 62/077,640, filed on Nov. 10, 2014.

(51) Int. Cl. G06Q 30/02

(52) U.S. Cl. CPC G06Q 30/0226

(57) ABSTRACT

An interface is created to allow users to request custom awards. The interface can allow a company to seamlessly incorporate functionality into its website or other user interface that will allow a user to request a custom award once an accomplishment (or recognition moment) is reached. In this way, a company can provide users with the option of deciding whether to request an award.

### CROSS-REFERENCE TO RELATED APPLICATIONS

This application claims priority to U.S. Provisional Application No. 62/077,640 filed on Nov. 10, 2014.

### BACKGROUND

Awards are commonly provided as a means for recognizing and individual. For example, many companies provide its employees with awards when the employees accomplish a task or exhibit a desired characteristic. Although these awards come in many different forms, they are oftentimes customized to include information about the individual receiving the award and/or the reason why the award is being presented.

To obtain such awards, a company will typically place an order to an award provider that specifies the desired type of award as well as any customizations to the award. Although this ordering model works well in many situations, it does not provide sufficient flexibility for use in some situations. For example, oftentimes a company may desire to provide an option for individuals to receive an award when the individuals accomplish a task. In such cases, once an individual accomplishes a task, it would be left to the individual to decide whether to receive a corresponding award. Using traditional ordering models, it can be difficult to adequately provide awards in such cases.

### BRIEF SUMMARY

The present invention extends to methods, systems, and computer program products for providing an interface to allow users to request custom awards. The interface of the present invention can allow a company to seamlessly incorporate functionality into its website or other user interface that will allow a user to request a custom award once an accomplishment (or recognition moment) is reached. In this way, a company can provide users with the option of deciding whether to request an award.

In one embodiment, the present invention is implemented as a method, performed by an award creator computer system, for creating an interface through which users can request customized versions of customizable awards. Input is received from a company computer system. The input defines a customizable award and includes an identification of one of more dynamic customizations to be made to the customizable award. An award data structure that defines the customizable award is created and stored on the award creator computer system. The award data structure includes a parameter for each dynamic customization. A request is received for the award. The request includes a personalization data structure which defines content to be assigned to each parameter. The content is dynamically determined based on a user that has requested a customized version of the customizable award. The content is assigned to each parameter in the award data structure. The customized version of the customizable award is then caused to be created based on the award data structure.

In another embodiment, the present invention is implemented as a method performed by a company computer system for creating an interface through which users can request customized versions of customizable awards. Input that defines a customizable award is sent to an award creator computer system. The input includes an identification of one of more dynamic customizations to be made to the customizable award. A personalization data structure which includes a parameter for each dynamic customization is received from the award creator computer system. User information is stored that defines one or more characteristics of an accomplishment that a user has reached. A request for a customized version of the customizable award to commemorate that the user has reached the accomplishment is received from a user computer system. An instance of the personalization data structure is populated with the user information such that user information is assigned to the parameter for each dynamic customization. A request for the customized version of the customizable award based on the instance of the personalization data structure is then sent to the award creator computer system.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIGS. 2A-2G illustrate example webpages of a website through which a company computer system can interact with an award creator computer system to create an interface for requesting customized awards;

FIGS. 3A-3C each illustrate an example data structure that can be stored by an award creator computer system to represent an award defined by a company computer system;

FIGS. 4A and 4B illustrate a process of requesting a customized version of an award using the techniques of the present invention;

FIG. 5 illustrates a flowchart of an example method for an award creator computer system to create an interface through which users can request customized versions of customizable awards; and

FIG. 6 illustrates a flowchart of an example method for a company computer system to create an interface through which users can request customized versions of customizable awards.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

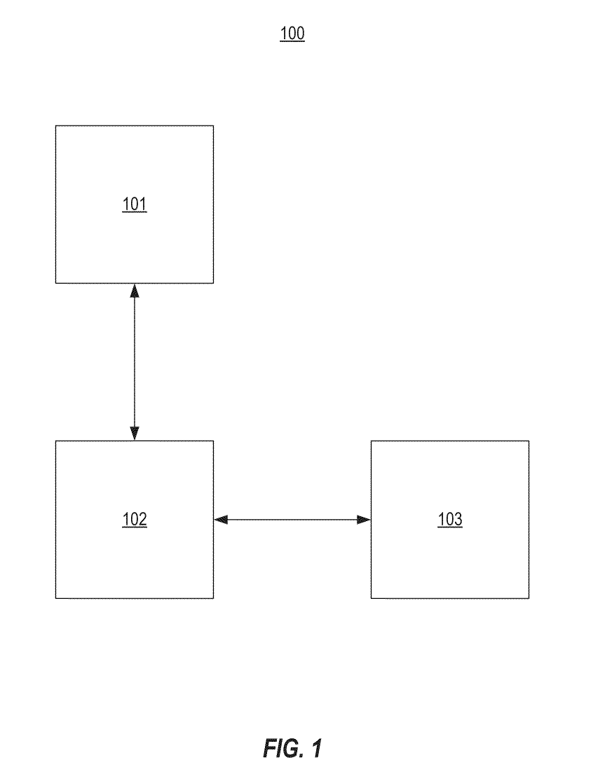

FIG. 1 illustrates an example computer environment 100 in which the present invention can be implemented. Computer environment 100 includes an award creator computer system 101, a company computer system 102, and a user computer system 103. Award creator computer system 101 can represent the computer system employed by a company that creates awards to receive orders for such awards. Company computer system 102 can represent the computer system employed by a company that desires to provide its users (e.g., employees, members, participants, customers, etc.) with an option to request an award once the users have reached an accomplishment. The term “company” will be used generally to represent one or more individuals (whether or not the individuals form a legal entity) that would like to provide an option for another individual to receive an award when the other individual reaches an accomplishment. User computer system 103 can represent any computing device employed by a user to communicate with company computer system 102 (e.g., a desktop or laptop computer or mobile device used to access a website or application provided by company computer system 102).

In this specification, the term “moment” will be used to refer to an achievement (or a “moment of recognition”) that a company desires to acknowledge. The term “moment data structure” or “award data structure” will be used to refer to a data structure that a company can create to define an award that is to be made available to the company's users when the users reach an associated moment.

As an initial overview of one or more embodiments of the present invention, award creator computer system 101 can provide an interface to allow a company, via company computer system 102, to define a moment data structure and to receive computer executable code which can be included in the company's website to allow its users to request an award associated with the moment. The computer executable code can be configured to obtain information about a user when the user requests an award. This information can be used to populate the corresponding moment data structure from which a version of the award personalized for the user can be created. In this way, the present invention allows a company to seamlessly provide customized awards to its users.

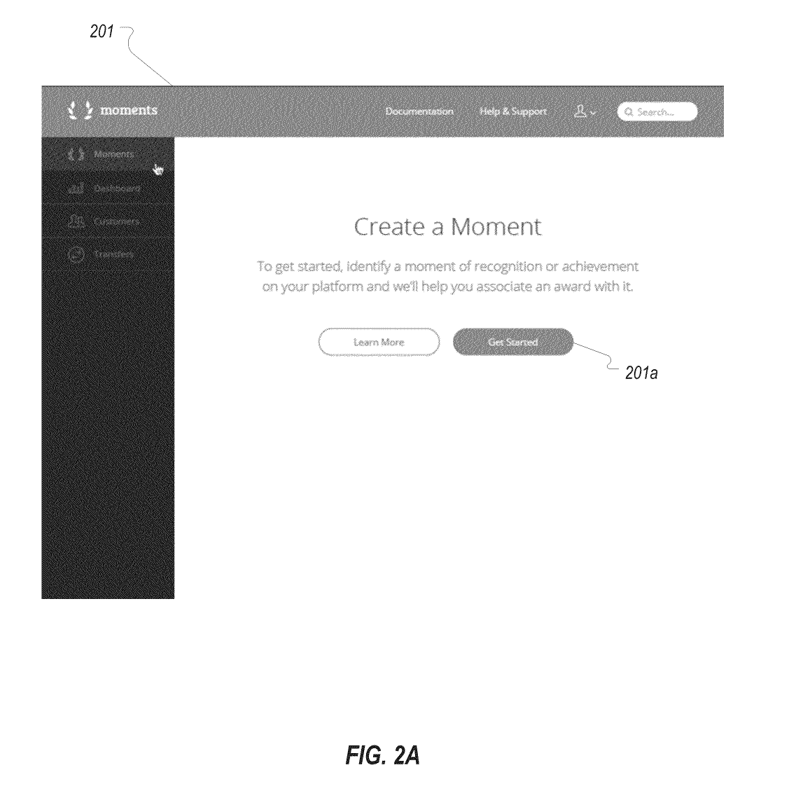

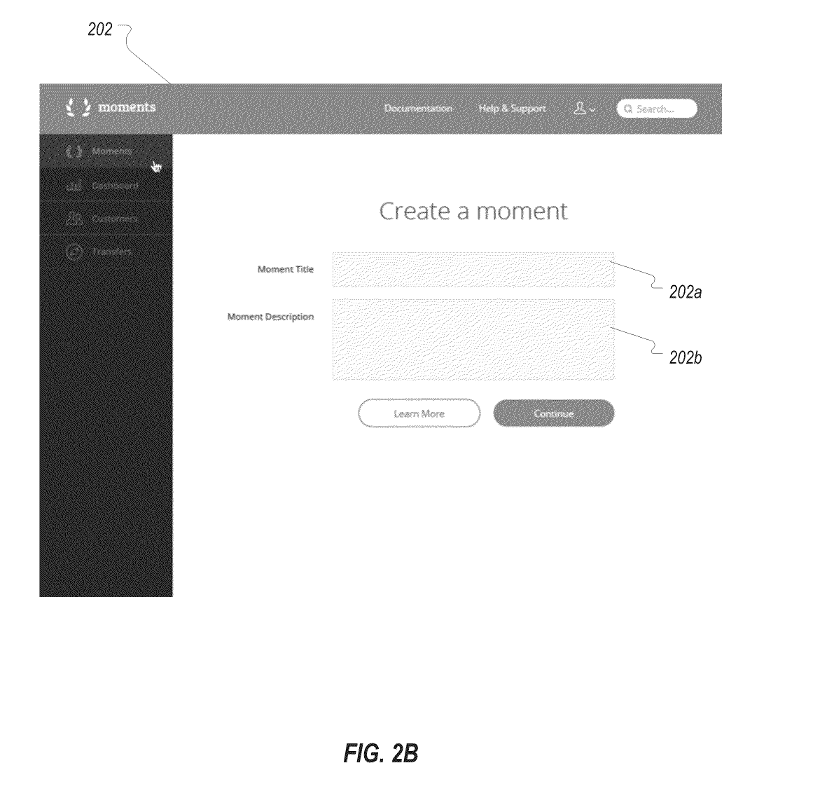

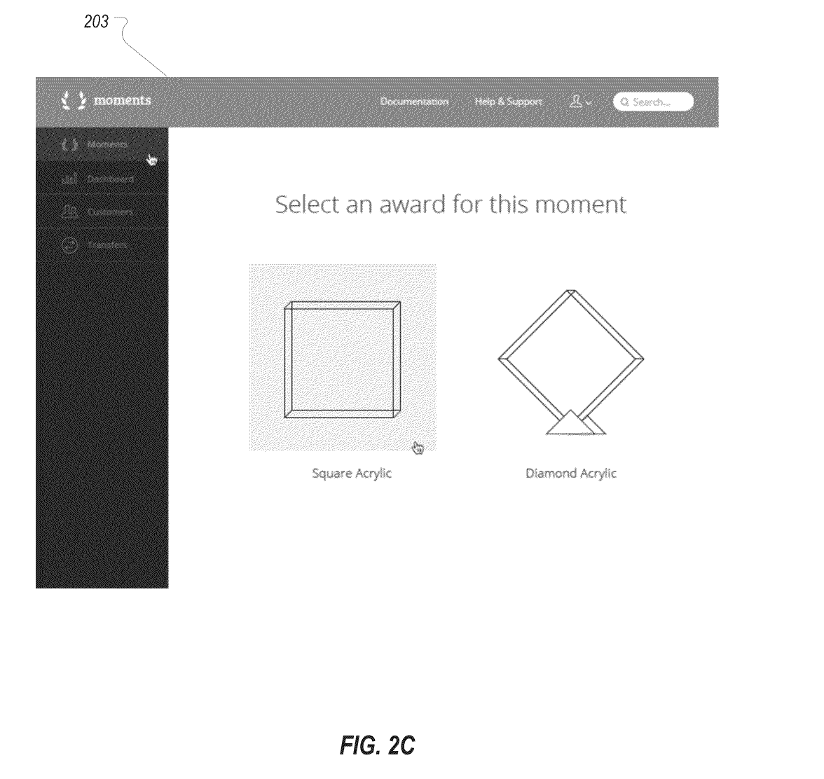

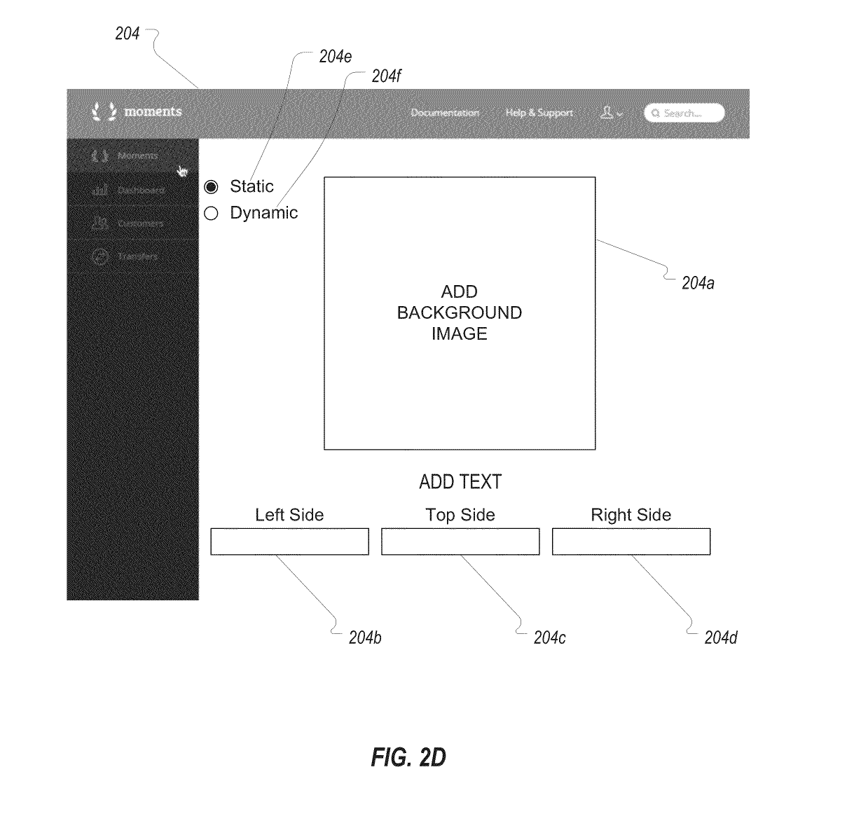

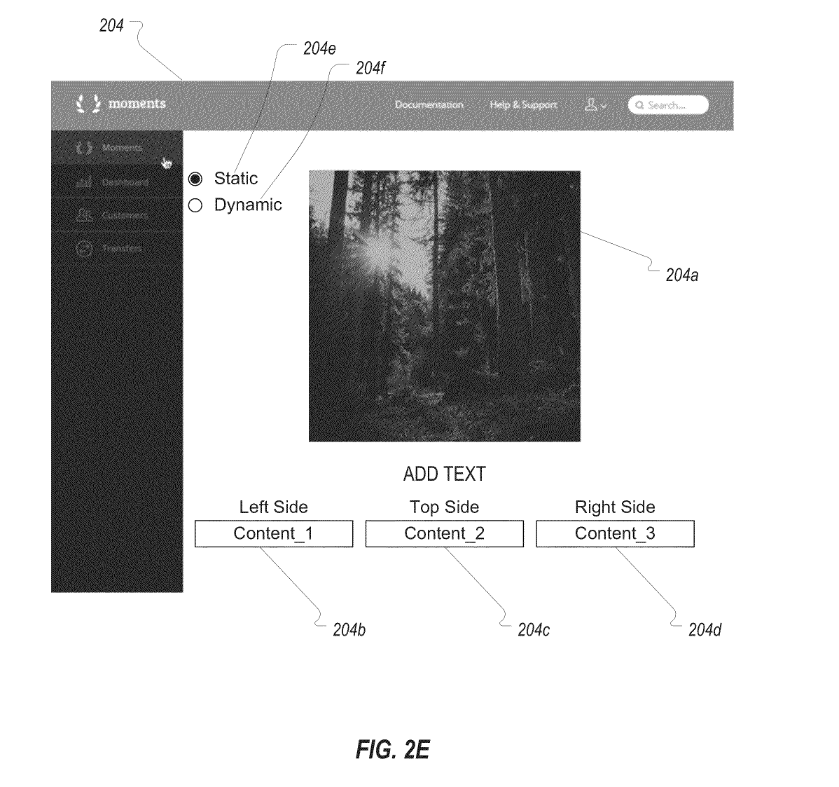

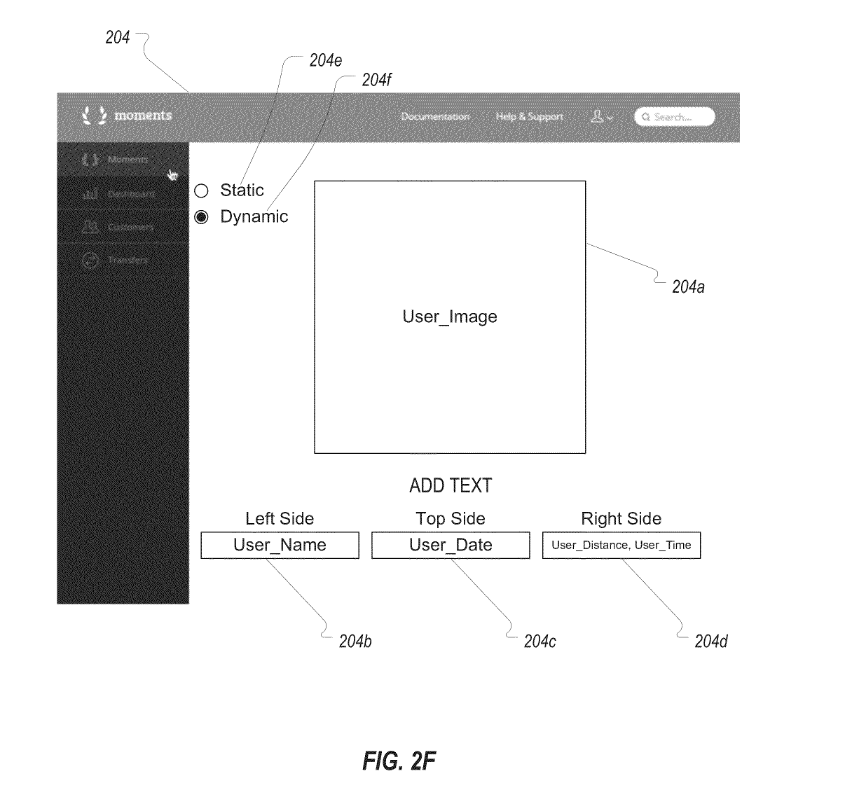

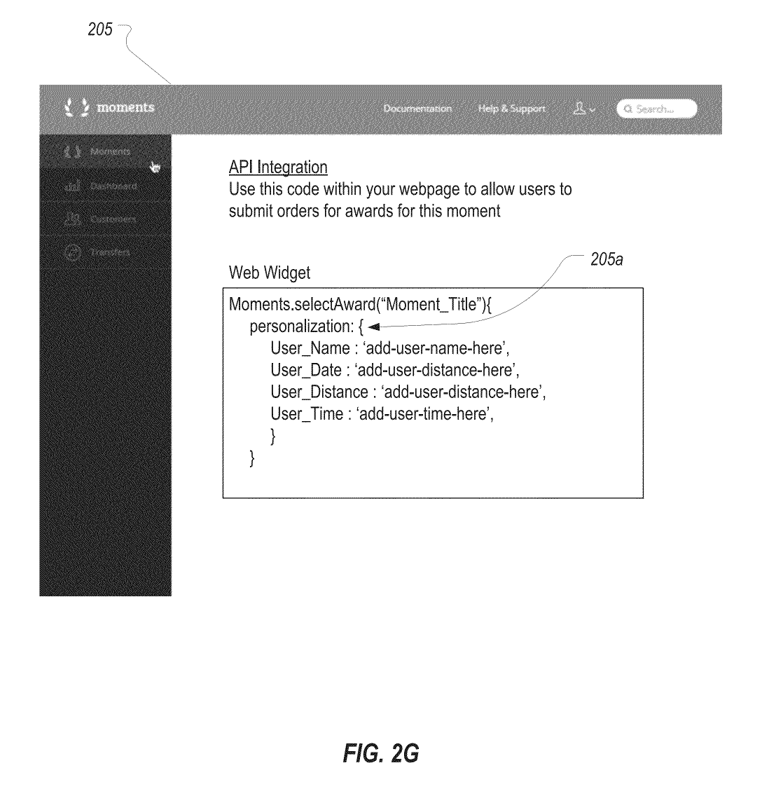

FIGS. 2A-2H illustrate various interfaces that award creator computer system 101 can present to company computer system 102 to guide a company through the process of defining a moment data structure and creating the code (hereinafter “moment code”) that can be embedded within the company's website. The interfaces depicted in these figures are shown as webpages of a website (hereinafter “moments website”). However, the interfaces could also be provided in the form of a mobile application or other type of interface.

FIG. 2A illustrates a webpage 201 that can initially be displayed to a company when the company visits the moments website. Webpage 201 includes a button 201a to allow the company to commence the process of creating a moment. As will be described below, the process of creating a moment generally encompasses defining a moment data structure and creating the moment code.

FIG. 2B illustrates a webpage 202 that can be displayed when the company selects button 201a. Webpage 202 includes a field 202a for receiving a title of the moment and a field 202b for receiving a description of the moment. In some embodiments, the title that is entered into field 202a can serve as a unique identifier for the moment. However, in other embodiments, a separate unique identifier could be assigned.

FIG. 2C illustrates a webpage 203 that displays various types of awards that are available for the company to offer to users when the users reach the moment. In webpage 203, a square acrylic award and a diamond acrylic award are available for the company to select. However, virtually any type of award that can be customized in any manner can be made available.

Each type of award will provide various customizations. For example, an acrylic award may be customized by adding a background image and one or more engravings on any of the surfaces of the award. These customizations can either be static customizations or dynamic customizations. In either case, the company selects which customizations are applied to the award; however, the source of the content of the customization will depend on whether the customization is static or dynamic. A static customization to an award is one where the content of the customization (e.g., the text, icon, image, etc.) is selected by the company and is applied to each instance of the award (i.e., it does not vary based on the user). A dynamic customization to an award is one where the content of the customization is based on the user requesting the award.

FIG. 2D illustrates a webpage 204 that can be displayed when the company selects the square acrylic award in webpage 203. Webpage 204 provides an example of how a company can specify which customizations will be included on the square acrylic award. Webpage 204 provides four customizations that the company can select to include: a background image option 204a, a left side text option 204b, a top side text option 204c, and a right side text option 204d. Of course, many other customization options could also be provided including, for example, an option for placing text on the front surface of the award. The type and number of customizations that are provided will be based on the type of award selected.

Webpage 204 also provides a static option 204e and a dynamic option 204f which can be selected to specify whether the customizations are static or dynamic. For ease of illustration, static option 204e and dynamic option 204f are shown as applying to each of the customizations. However, in a typical implementation, each customization will have its own options so that any particular customization can be specified as either static or dynamic independently of other customizations.

In FIG. 2D, webpage 204 shows that static option 204e has been selected. Therefore, each of customizations 204a-204d will be static customizations where the company specifies the content of the customizations. FIG. 2E illustrates webpage 204 after the company has provided input specifying the content of customizations 204a-204d. As shown, an image of a forest has been selected for customization 204a and text content of “Content_1,” “Content_2,” and “Content_3” has been selected for customizations 204b-204d respectively. Because these customizations are all static, each award requested by a user will include the specified content.

In contrast, FIG. 2F illustrates the case when dynamic option 204f has been selected. In such a case, the content of each customization will be dependent on the user that requests the award. Accordingly, rather than specifying the content of the customization, the company can specify a parameter name to which the content will be assigned once an award is requested. For example, FIG. 2F shows that the company has input a parameter name of User_Image for customization 204a, User_Name for customization 204b, User_Date for customization 204c, and combined parameter names of User_Distance and User_Time for customization 204d. As will be further described below, the company can use these parameter names to dynamically provide the content for the customizations when a user requests an award. Alternatively, rather than having company computer system 102 provide parameter names, a default parameter name could be provided for each customization.

Regardless of whether any of the customizations to an award are static or dynamic, award creator computer system 101 can create a moment data structure which defines the award associated with a particular moment. In other words, the moment data structure for a particular moment can include computer executable instructions for creating an award once a user, who has reached the associated moment, requests the award.

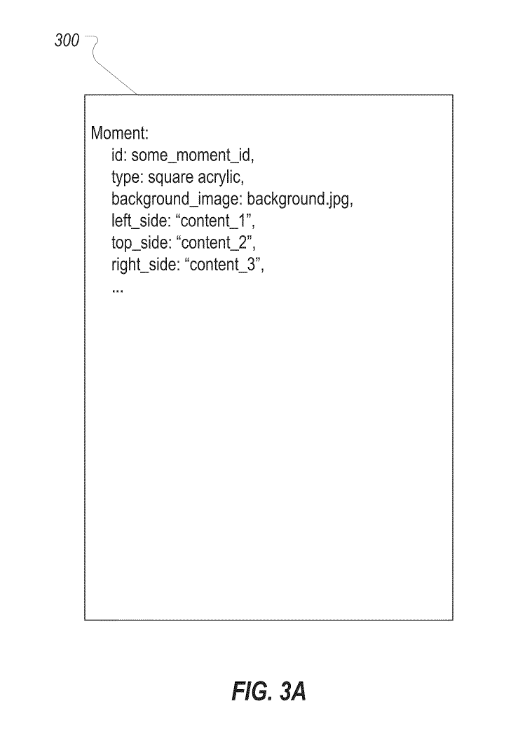

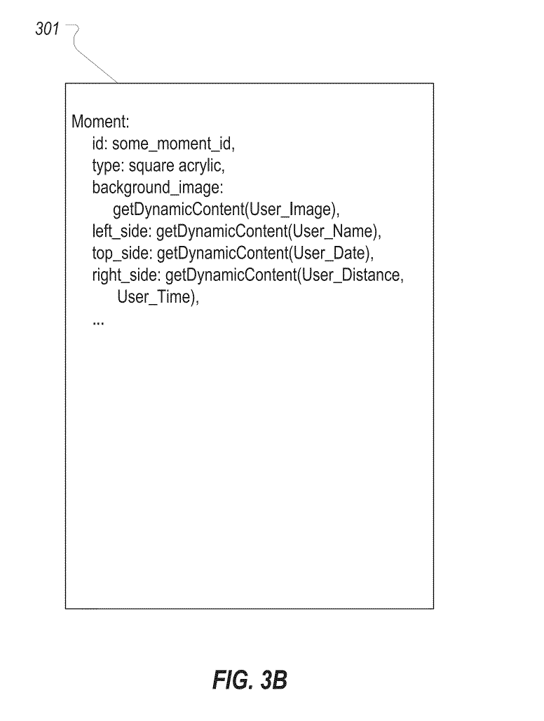

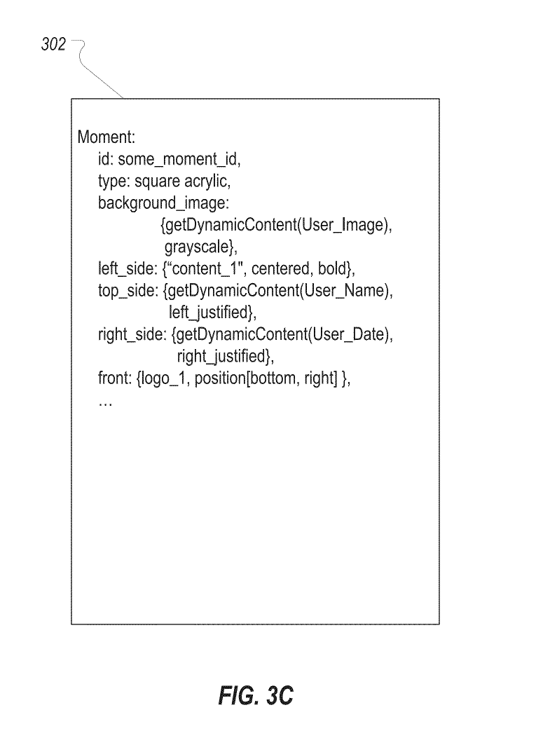

FIG. 3A illustrates an example moment data structure 300 that can be created in response to the input received in FIG. 2E. Moment data structure 300 therefore defines an award that includes static content for each of customizations 204a-204d. As shown, moment data structure 300 defines an identifier for the moment (e.g., the moment title input into field 202a or other unique identifier). The identifier can be used by company computer system 102 when making a request for an award to identify the moment to which the request pertains. Moment data structure 300 also defines the type of the award which in this example is square acrylic. Moment data structure 300 further defines the customizations to be made to the award as well as the static content assigned to the customizations which in this case are background.jpg, “Content_1,” “Content_2,” and “Content_3.” As indicated by the ellipsis, moment data structure 300 can include additional information which defines additional customizations.

FIG. 3B illustrates an example moment data structure 301 that can be created in response to the input received in FIG. 2F. Moment data structure 301 therefore defines an award that will include dynamic content for each of customizations 204a-204d. As shown, moment data structure 301, like moment data structure 300, defines an identifier for the moment and the type of the award. Moment data structure 301 also defines the customizations to be made to the award. However, the content of the customizations is not defined. Rather, functions for obtaining the content dynamically when a request is received is defined. This dynamic determination of the content is represented using the function getDynamicContent with the parameter(s) of the function being the parameter name(s) provided in FIG. 2F. This getDynamicContent function is merely a generalized example of how the content of the customizations can be dynamically assigned. One of the skill in the art understands that many different programming constructs can be employed to assign dynamically determined content to the customizations.

FIG. 3C illustrates another example moment data structure 302 that is similar to moment data structures 300 and 301 but includes both static and dynamic customizations. Moment data structure 302 also includes additional information to illustrate various examples of how the content of the customization can be further customized. For example, moment data structure 302 defines that the background image customization is dynamically determined based on a received value of the User_Image parameter and that the image should be formatted as grayscale. The left side text customization defines that the static content “Content_1” should be centered on the left side of the award and formatted as bold text. The content of the top side text customization is dynamically determined based on a received value of the User_Name parameter and should be left justified on the top side of the award. Similarly, the content of the right side text customization is dynamically determined based on a received value of the User_Date parameter and should be right justified on the right side of the award. Finally, moment data structure 302 defines a front customization having static content of a logo that should be positioned on the bottom right corner of the front surface of the award.

The customizations provided in the above examples are merely examples of customizations that may be suitable for a square acrylic award. Other types of awards may provide many different types of customizations. Accordingly, the present invention should not be limited by the type of award or the type of customizations that are provided for any particular award.

After the company has finished defining the award for a particular moment, the moments website can generate computer executable code that can be incorporated into the company's website to allow users of the company's website to request an award upon reaching the corresponding moment. In other words, award creator computer system 101 can generate code to allow company computer system 102 to easily integrate its website with an application programming interface (“API”) through which awards can be requested.

FIG. 2G illustrates an example of sample code that can be used to request the award that was defined in FIG. 2F. Because the award defined in FIG. 2F includes four customizations having dynamically assigned content, the sample code defines a personalization data structure 205a for holding the dynamically assigned content. Personalization data structure 205a comprises a container for the dynamically assigned content that company computer system 102 can send to award creator computer system 101. Award creator computer system 101 can then use an instance of personalization data structure 205a to assign the content to the appropriate customizations within moment data structure 301. For example, personalization data structure 205a is structured as a set of parameter/value pairs. Because award creator computer system 101 does not know how company computer system 102 will access/determine the dynamic content, the value of each parameter/value pair in the sample code is merely an instruction describing what content should be assigned by company computer system 102 to the parameter prior to submitting a request for an award. Once company computer system 102 copies the sample code into its website, modifications will need to be made to cause the appropriate values to be assigned to the parameters prior to sending a request for an award.

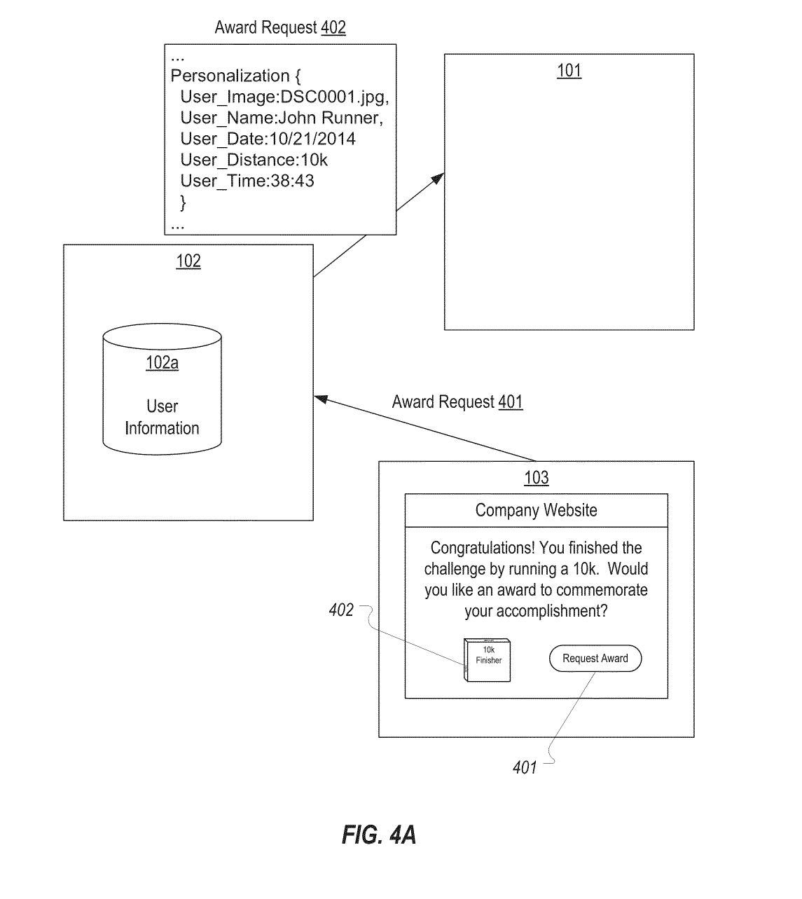

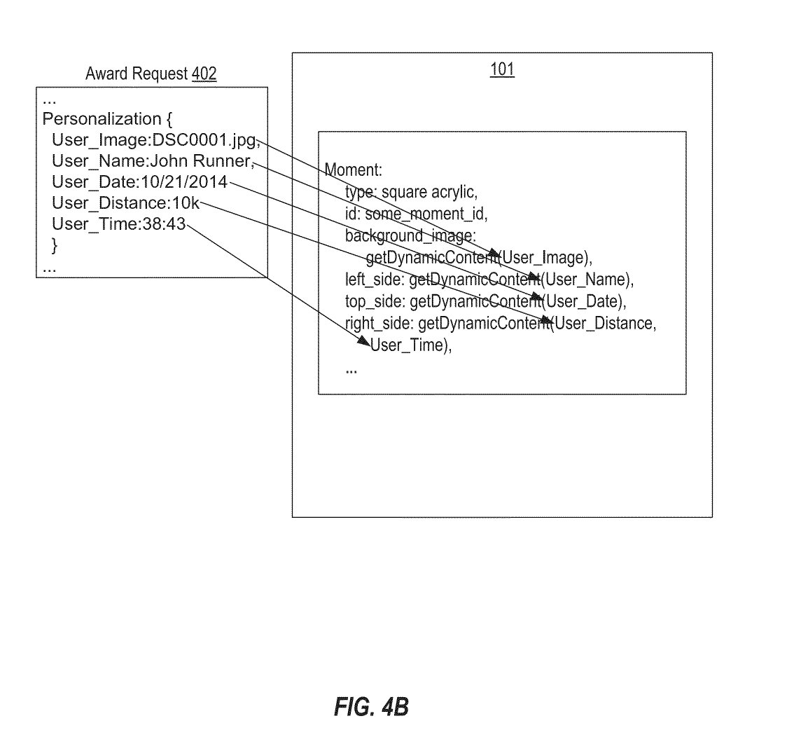

FIGS. 4A and 4B illustrate an example process of how personalization data structure 205a is populated and sent by company computer system 102 to award creator computer system 101 in response to a user request for an award that is received from user computer system 103. As shown, a user has accessed the company's website which displays that the user has reached a moment. In this example, the moment is the running of a 10 kilometer race. The company website displays an example of the award 402 that the user can receive. The company website also includes a request award button 401. The company website can be configured to include the sample code shown in FIG. 2G and to cause this sample code to be invoked when the user selects request award button 401.

When the user selects request award button 401, an award request 401 can be sent to company computer system 102 indicating that the user would like to receive the award corresponding to the moment. Company computer system 102 can then access information stored about the requesting user (e.g., the user's name, the date the moment was reached, and the distance and time) which may be stored in a database 102a. The information about the user can be used to populate personalization data structure 205a which can then be included in an award request 402 sent to award creator computer system 101. The exact nature of award request 402 will vary depending on the details of any particular implementation. However, award request 402 should include the personalization data structure as well as an identifier of the moment (e.g., the moment title or other unique identifier) to which the request pertains.

FIG. 4B illustrates how award creator computer system 101 can retrieve the user information contained within personalization data structure 205a and assign it to the appropriate customization. In this way, the content of each of the dynamic customizations can be dynamically assigned based on the requesting user. Once the content of each of the dynamic customizations has been assigned, award creator computer system 101 can cause the award to be created and shipped to the user.

Although FIG. 4A illustrates that user computer system 103 communicates award request 401 to company computer system 102 which then causes company computer system 102 to send award request 402 to award creator computer system 101, the sequence of communications can be altered in some embodiments of the invention. For example, company computer system 102 could provide user computer system 103 with the necessary information (whether before or after the user selects request award button 401) to allow user computer system 103 to submit award request 402 directly to award creator computer system 101.

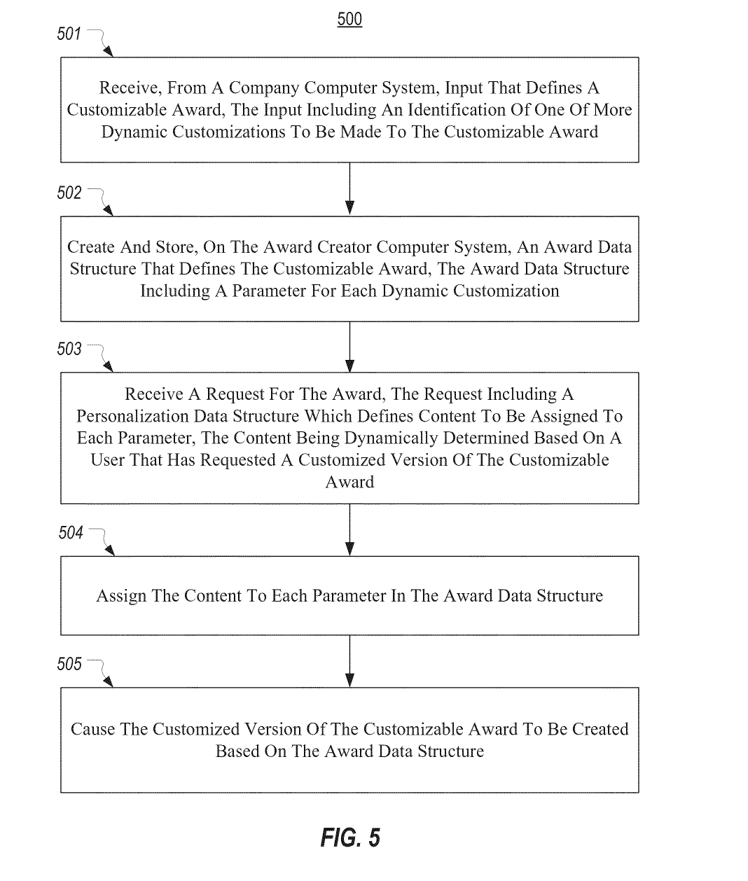

FIG. 5 illustrates a flowchart of an example method 500 that an award creator computer system can implement to create an interface through which users can request customized versions of customizable awards.

Method 500 includes an act 501 of receiving, from a company computer system, input that defines a customizable award, the input including an identification of one of more dynamic customizations to be made to the customizable award. For example, award creator computer system 101 can receive input from company computer system 102 via the moments website. The input can include an identification that customizations 204a-204d are dynamic.

Method 500 includes an act 502 of creating and storing, on the award creator computer system, an award data structure that defines the customizable award, the award data structure including a parameter for each dynamic customization. For example, award creator computer system 101 can create and store moment data structure 301 which includes parameters for customizations 204a-204d.

Method 500 includes an act 503 of receiving a request for the award, the request including a personalization data structure which defines content to be assigned to each parameter, the content being dynamically determined based on a user that has requested a customized version of the customizable award. For example, award creator computer system 101 can receive award request 402 that includes personalization data structure 205a having information specific to the user that has requested the award.

Method 500 includes an act 504 of assigning the content to each parameter in the award data structure. For example, award creator computer system 101 can assign the content in personalization data structure 205a that is included in award request 402 to the parameters for each of the dynamic customizations in moment data structure 301.

Method 500 includes an act 505 of causing the customized version of the customizable award to be created based on the award data structure. For example, award creator computer system 101 can use moment data structure 301, after it has been updated with the content of personalization data structure 205a, to cause a customized version of the award to be created.

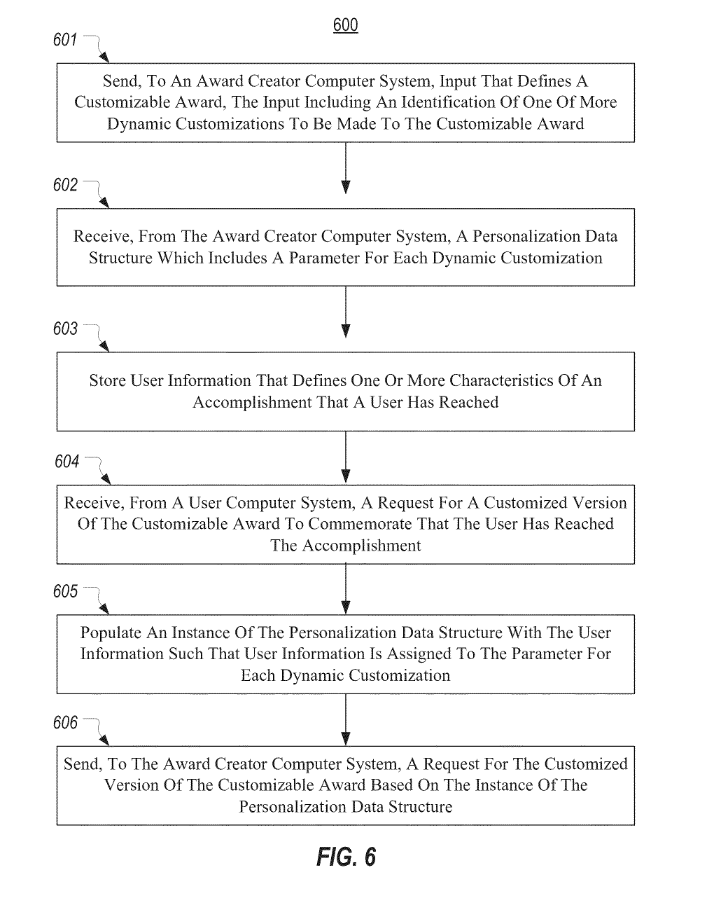

FIG. 6 illustrates a flowchart of an example method 600 that a company computer system can implement to create an interface through which users can request customized versions of customizable awards.

Method 600 includes an act 601 of sending, to an award creator computer system, input that defines a customizable award, the input including an identification of one of more dynamic customizations to be made to the customizable award. For example, company computer system 102 can interact with the moments website provided by award creator computer system 101 including indicating that customizations 204a-204d are dynamic.

Method 600 includes an act 602 of receiving, from the award creator computer system, a personalization data structure which includes a parameter for each dynamic customization. For example, company computer system 102 can receive personalization data structure 205a that includes parameters for customizations 204a-204d.

Method 600 includes an act 603 of storing user information that defines one or more characteristics of an accomplishment that a user has reached. For example, company computer system 102 can store user information in database 102a which indicates that the user has completed a 10 kilometer race on a particular date and in a particular time.

Method 600 includes an act 604 of receiving, from a user computer system, a request for a customized version of the customizable award to commemorate that the user has reached the accomplishment. For example, company computer system 102 can receive a request from user computer system 103 when the user selects button 401.

Method 600 includes an act 605 of populating an instance of the personalization data structure with the user information such that user information is assigned to the parameter for each dynamic customization. For example, company computer system 102 can populate an instance of personalization data structure 205a with user information from database 102a.

Method 600 includes an act 606 of sending, to the award creator computer system, a request for the customized version of the customizable award based on the instance of the personalization data structure. For example, company computer system 102 can send award request 402, which includes an instance of personalization data structure 205a that includes the user's information, to award creator computer system 101.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, performed by an award creator computer system, for creating an interface through which users can request customized versions of customizable awards, the method comprising:
receiving, from a company computer system, input that defines a customizable award, the input including an identification of one of more dynamic customizations to be made to the customizable award;
creating and storing, on the award creator computer system, an award data structure that defines the customizable award, the award data structure including a parameter for each dynamic customization;
receiving a request for the award, the request including a personalization data structure which defines content to be assigned to each parameter, the content being dynamically determined based on a user that has requested a customized version of the customizable award;
assigning the content to each parameter in the award data structure; and
causing the customized version of the customizable award to be created based on the award data structure.

2. The method of claim 1, further comprising:
generating code which is configured to create the request that includes the personalization data structure; and
providing the code to the company computer system to allow the company computer system to incorporate the code into a website to be invoked when a user requests the customized version of the customizable award.

3. The method of claim 1, wherein the input that defines the customizable award also includes an indication of one or more static customizations to be made to the customizable award, each indication of a static customization including content for the static customization; and
wherein the award data structure includes the content for each static customization.

4. The method of claim 1, wherein the one or more dynamic customizations include one or more of a picture or text.

5. The method of claim 1, wherein the content of the one or more dynamic customizations comprises one or more of a name of the user, a date when the user reached an accomplishment for which the customizable award is provided, or one or more characteristics of the accomplishment.

6. The method of claim 1, wherein the request for the customized version of the customizable award is received from the company computer system.

7. The method of claim 1, wherein the one or more dynamic customizations comprise text and at least one of the dynamic customizations is associated with a format or position for the text.

8. The method of claim 7, wherein the format or position for the text is specified in the input that defines the customizable award.

9. The method of claim 1, wherein the customizable award comprises acrylic.

10. A method, performed by a company computer system, for creating an interface through which users can request customized versions of customizable awards, the method comprising:
sending, to an award creator computer system, input that defines a customizable award, the input including an identification of one of more dynamic customizations to be made to the customizable award;
receiving, from the award creator computer system, a personalization data structure which includes a parameter for each dynamic customization;
storing user information that defines one or more characteristics of an accomplishment that a user has reached;
receiving, from a user computer system, a request for a customized version of the customizable award to commemorate that the user has reached the accomplishment;
populating an instance of the personalization data structure with the user information such that user information is assigned to the parameter for each dynamic customization; and
sending, to the award creator computer system, a request for the customized version of the customizable award based on the instance of the personalization data structure.

11. The method of claim 10, further comprising:
receiving, from the award creator computer system, code which when executed causes the request for the customized version of the customizable award to be sent to the award creator computer system.

12. The method of claim 10, wherein the input that defines the customizable award includes an identification of one or more static customizations to be made to the customizable award, each indication of a static customization including content for the static customization.

13. The method of claim 10, wherein the user information includes one or more of a picture or text.

14. The method of claim 10, wherein the user information comprises one or more of a name of the user, a date when the user reached the accomplishment, or one or more characteristics of the accomplishment.

15. The method of claim 10, wherein the request for the customized version of the customized award that is received from the user computer system is received in response to the user selecting an option on a website provided by the company computer system.

16. The method of claim 10, wherein the identification of the one of more dynamic customizations to be made to the customizable award specifies a format or a position of the content of the dynamic customization.

17. One or more computer storage media storing computer executable instructions which when executed on one or more processors implement a method for creating an interface through which users can request customized versions of customizable awards, the method comprising:
receiving, from a company computer system, input that defines a customizable award, the input including an identification of one of more dynamic customizations to be made to the customizable award;
creating and storing, on the award creator computer system, an award data structure that defines the customizable award, the award data structure including a parameter for each dynamic customization;
receiving a request for the award, the request including a personalization data structure which defines content to be assigned to each parameter, the content being dynamically determined based on a user that has requested a customized version of the customizable award;
assigning the content to each parameter in the award data structure; and
causing the customized version of the customizable award to be created based on the award data structure.

18. The computer storage media of claim 17, wherein the method further comprises:
generating code which is configured to create the request that includes the personalization data structure; and
providing the code to the company computer system to allow the company computer system to incorporate the code into a website to be invoked when a user requests the customized version of the customizable award.

19. The computer storage media of claim 17, wherein the input that defines the customizable award also includes an indication of one or more static customizations to be made to the customizable award, each indication of a static customization including content for the static customization; and
wherein the award data structure includes the content for each static customization.

20. The computer storage media of claim 17, wherein the content of the one or more dynamic customizations comprises one or more of a name of the user, a date when the user reached an accomplishment for which the customizable award is provided, or one or more characteristics of the accomplishment.
